(19) United States
(12) Patent Application Publication
(10) Pub. No.: US 2025/0035498 A1
(43) Pub. Date: Jan. 30, 2025

(54) FORCE SENSOR, SYSTEM INCLUDING THE SAME, AND METHOD OF MANUFACTURING THE SAME

(71) Applicant: Jace Leslie CHIPMAN, Fairfax, VA (US)

(72) Inventor: Jace Leslie CHIPMAN, Fairfax, VA (US)

(21) Appl. No.: 18/359,440

(22) Filed: Jul. 26, 2023

(51) Int. Cl. G01L 9/06; G01L 9/08; G06F 3/01

(52) U.S. Cl. CPC G01L 9/06; G01L 9/08; G06F 3/014

(57) ABSTRACT

A force sensor includes first and second layers formed from an electrically conductive material. The force sensor further includes a third layer formed from a piezoresistive material disposed between the first and second layers. The force sensor can be incorporated into a device, e.g., a pushbutton type of device, that emits a signal in proportional response to a force being applied to the sensor, e.g., pushing the button.

### BACKGROUND

Electronics have been used in various manufactured materials. Devices such as conductive traces, bio-sensors, electrodes, computers, electronic circuits, and the like have all been incorporated into textiles resulting in textile electronics. Examples of systems that include textile electronics include virtual reality (VR) systems.

### BRIEF DESCRIPTION OF THE FIGURES

These and other features and advantages of the present invention will be better understood by reference to the following detailed description when considered in conjunction with the accompanying data and figures wherein:

FIG. 1A is a side view of a sensor in accordance with some embodiments.

FIG. 1B is an isometric view of a sensor in accordance with some embodiments.

FIG. 1C is an isometric half-exploded view of a sensor in accordance with some embodiments.

FIG. 1D is an isometric exploded view of a sensor in accordance with some embodiments.

FIG. 2A is a side view of a wrapped piezoresistive sensor unrolled, in accordance with some embodiments.

FIG. 2B is an isometric view of a sensor unrolled, in accordance with some embodiments.

FIG. 2C is a top view of an unrolled sensor in accordance with some embodiments.

FIG. 2D is a bottom view of an unrolled sensor in accordance with some embodiments.

FIG. 3A is a side view of a flattened sensor in accordance with some embodiments.

FIG. 3B is an isometric view of a flattened sensor in accordance with some embodiments.

FIG. 4A is an isometric view of an unrolled sensor with a wrapping-element in accordance with some embodiments.

FIG. 4B is a top view of an unrolled sensor with a wrapping-element in accordance with some embodiments.

FIG. 4C is a bottom view of an unrolled sensor with a wrapping-element in accordance with some embodiments.

FIG. 4D is a side view of an unrolled sensor with a wrapping-element in accordance with some embodiments.

FIG. 5A is an isometric view of a sensor with a wrapping-element in accordance with some embodiments.

FIG. 5B is an isometric view of a flattened sensor with a wrapping-element in accordance with some embodiments.

FIG. 6 is a flowchart of a method of manufacture in accordance with some embodiments.

FIGS. 7A-7B are corresponding top views of a glove that incorporates piezoresistive sensors, in accordance with some embodiments.

### DETAILED DISCLOSURE

As benefits associated with the various types and configurations of textile electronics have become apparent, a need for simple, effective, efficient, and intuitive solutions has become evident.

As input devices and interfaces complementary to various electronic functions and systems have evolved, a need for correspondingly adapted textile electronics and material combinations has become evident.

The embodiments of the invention described herein are not intended to be exhaustive or to limit the invention to precise forms disclosed. Rather, the embodiments selected for description have been chosen to enable one skilled in the art to practice the invention. The following examples are not intended to limit the scope of what the inventor regards as their invention, nor are they intended to represent that the experiments are all or the only experiments performed.

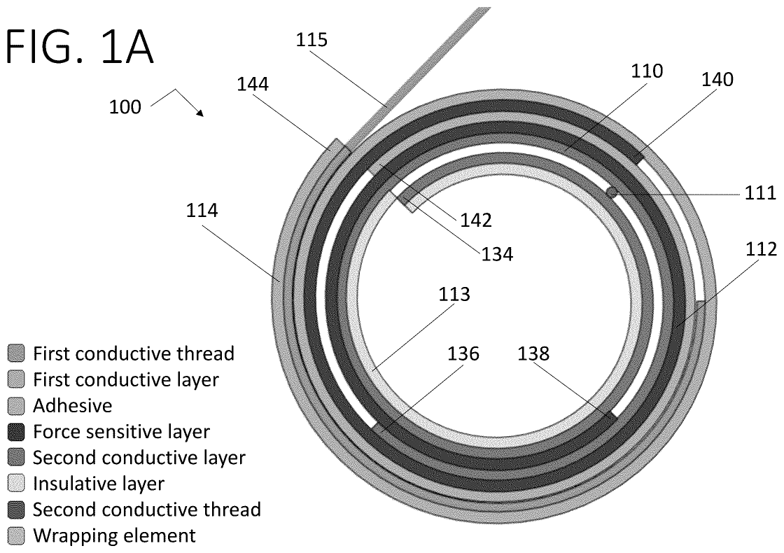

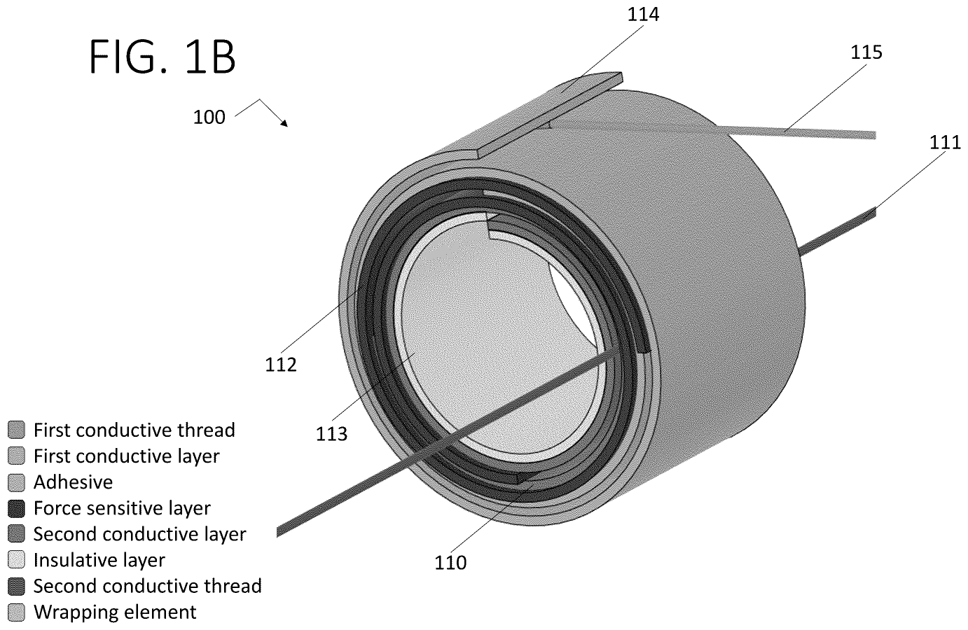

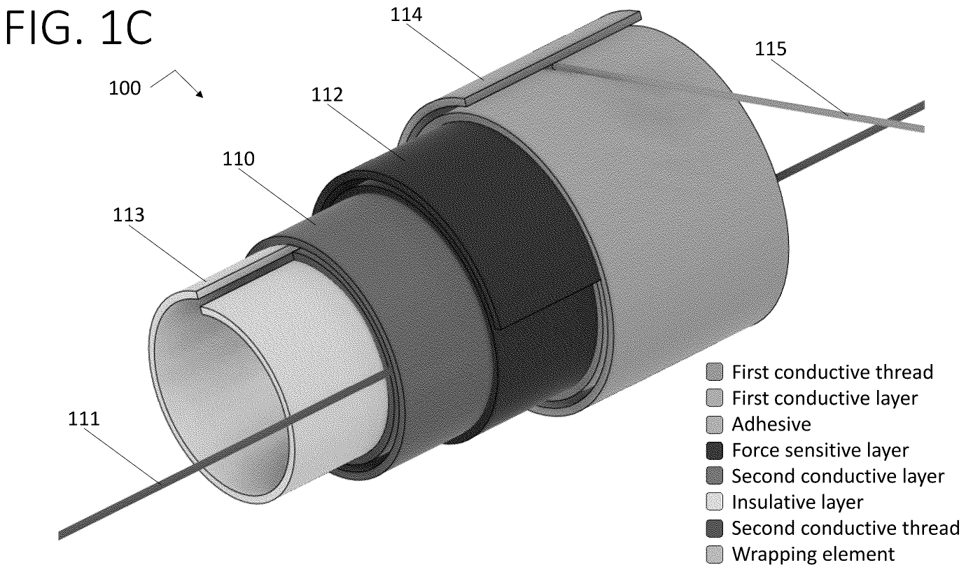

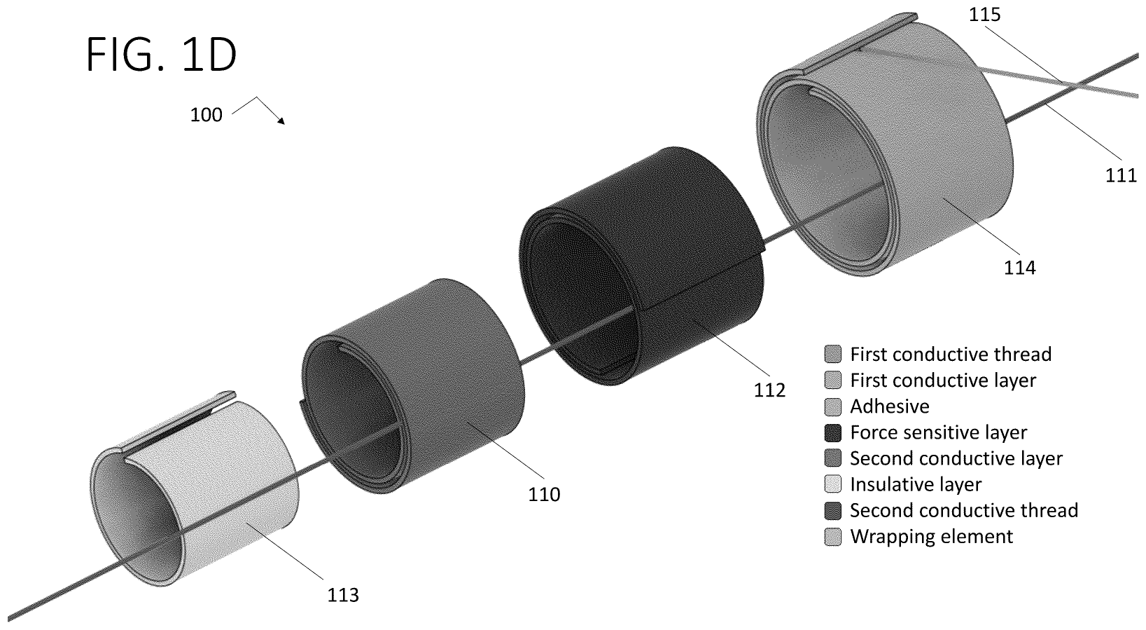

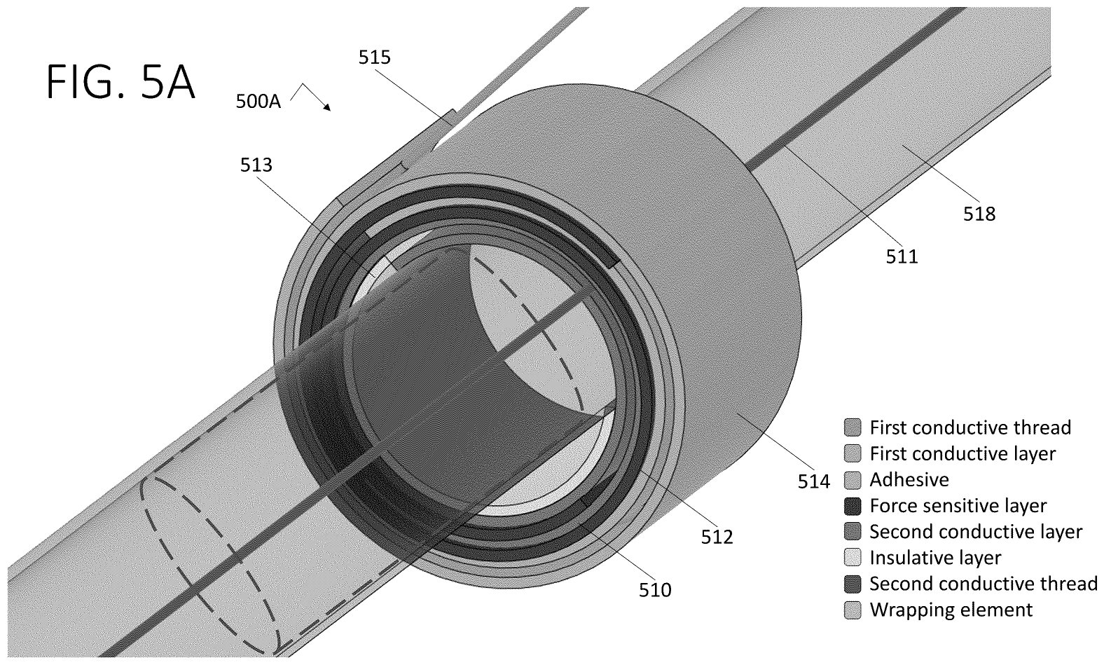

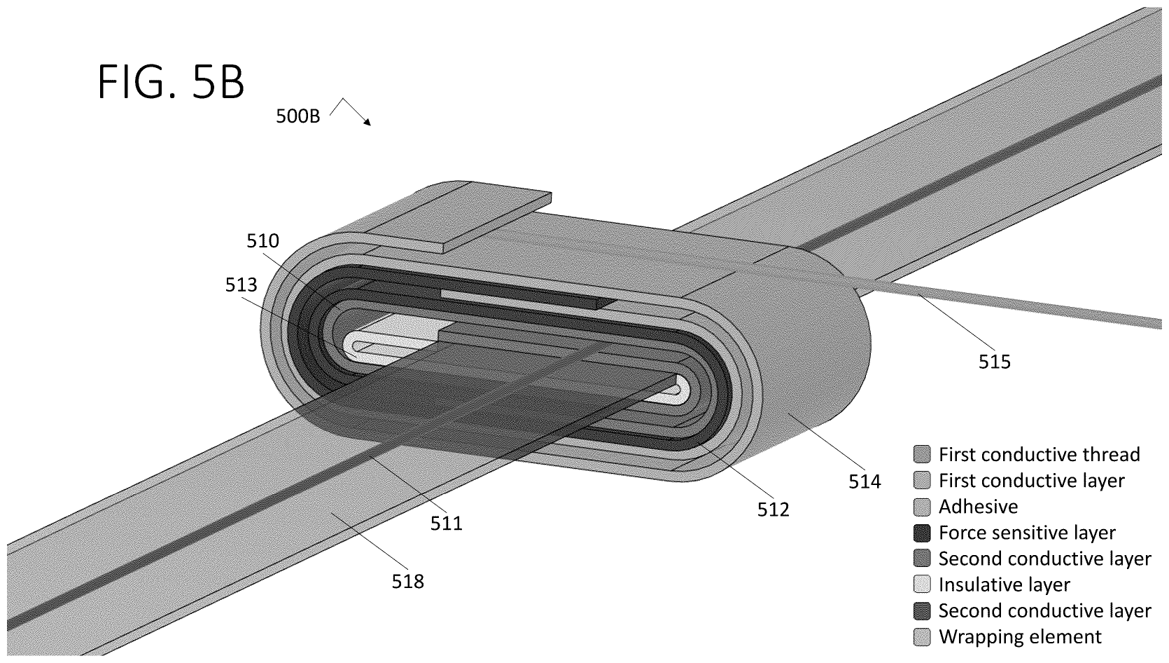

In some embodiments, a force sensor is configured as a spirally-wrapped layer whorl, e.g., 100 FIG. 1A. In some embodiments, e.g., as in FIG. 1 and FIG. 5, a force sensor 100 includes first, second and third layers that are stacked and wrapped in a whorl, i.e., a spirally-wrapped layer whorl. A spirally-wrapped layer whorl is a spiraled arrangement relative to a cylindrical coordinate system (CCS) having a cylindrical axis (e.g., Z-axis) extending in a first direction (e.g., Z-axis).

The first layer, 110, is an inner conductive layer, e.g., a layer of copper (Cu) foil. The second layer, 112, is a force-sensitive layer (e.g., piezo layer). The third layer, 114, is an outer conductive layer, e.g., a layer of copper (Cu) foil. In terms of the spiraled arrangement, the first layer 110 and third layer 114 relate to each other correspondingly as being relatively more inner and relatively more outer.

The first 110, second 112, and third 114 layers are stacked relative to a radial axis of the CCS. The first 110, second 112 and third 114 layers correspondingly have: length axes extending in a second direction (e.g., a tangential axis) perpendicular to each of the cylindrical axis (e.g., Z-axis) and the radial axis of the CCS; and width axes extending parallel the cylindrical axis (e.g., Z-axis) and perpendicular to the radial axis.

The first layer 110 has a first end 134 and a second end 136. The second layer 112 has a first end 138 and a second end 140. The third layer 114 has a first end 142 and a second end 144. Relative to the radial axis: the first 134, 138, 142 and second 136, 140, 144 ends correspondingly of the first 110, second 112, and third 114 layers are proximal and distal to the cylindrical axis; the first end 138 of the second layer 112 layer is between the first 134 and second 136 ends of the first layer 110; and the first end 142 of the third layer 114 layer is between the first 138 and second 140 ends of the second layer 112. The second layer 112 is a force-sensitive layer.

In FIGS. 1A-1D, force sensor 100 further includes conductive lines 111 and 115 correspondingly coupled electrically to the conductive layers 110 and 114. In some embodiments, lines 111 and 115 are conductive threads.

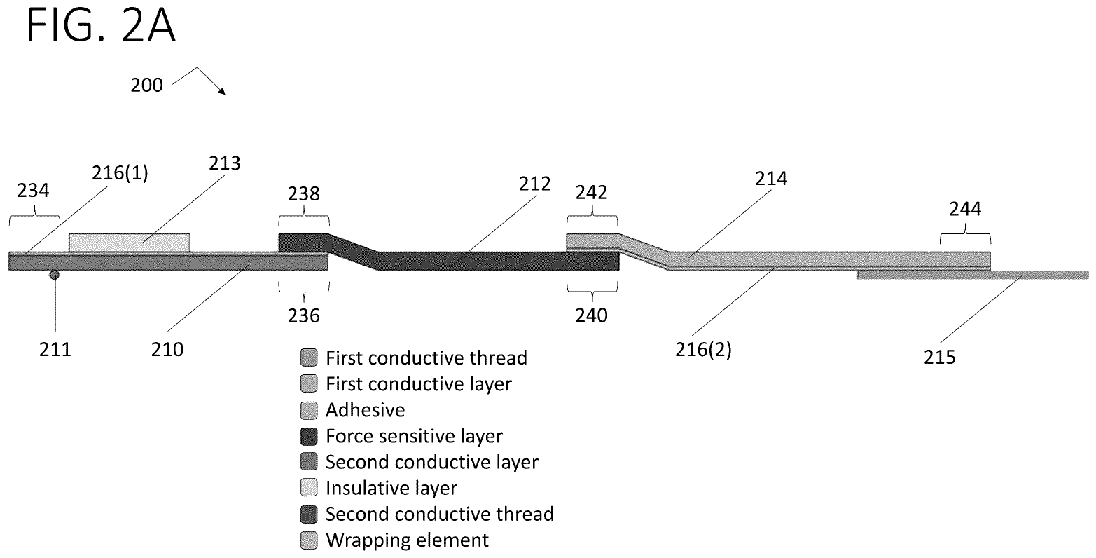

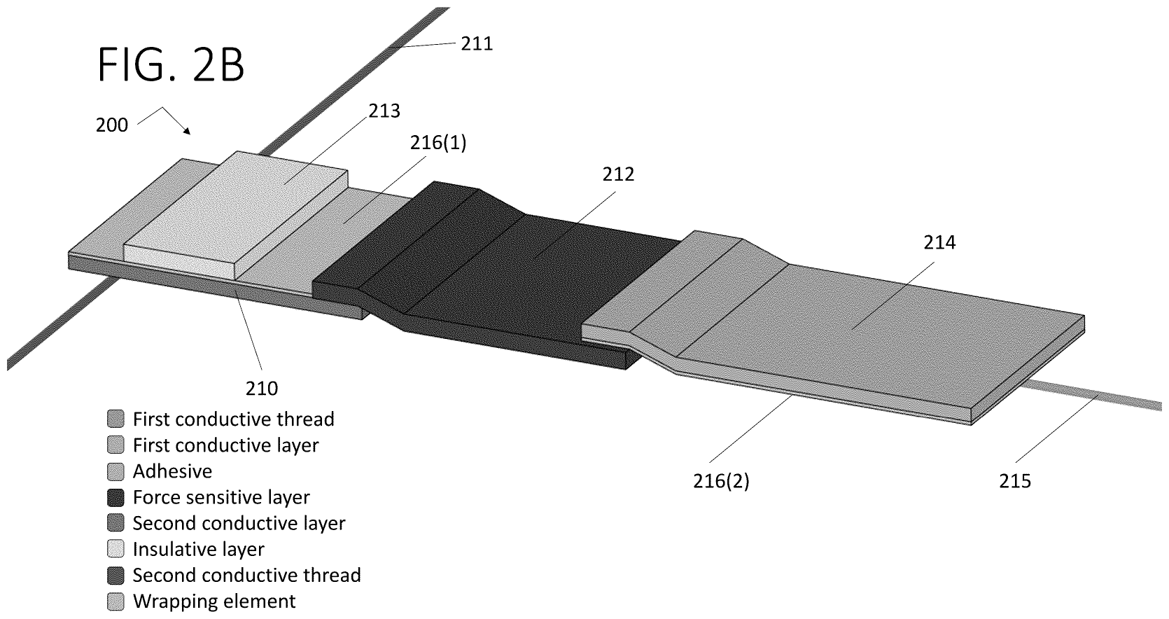

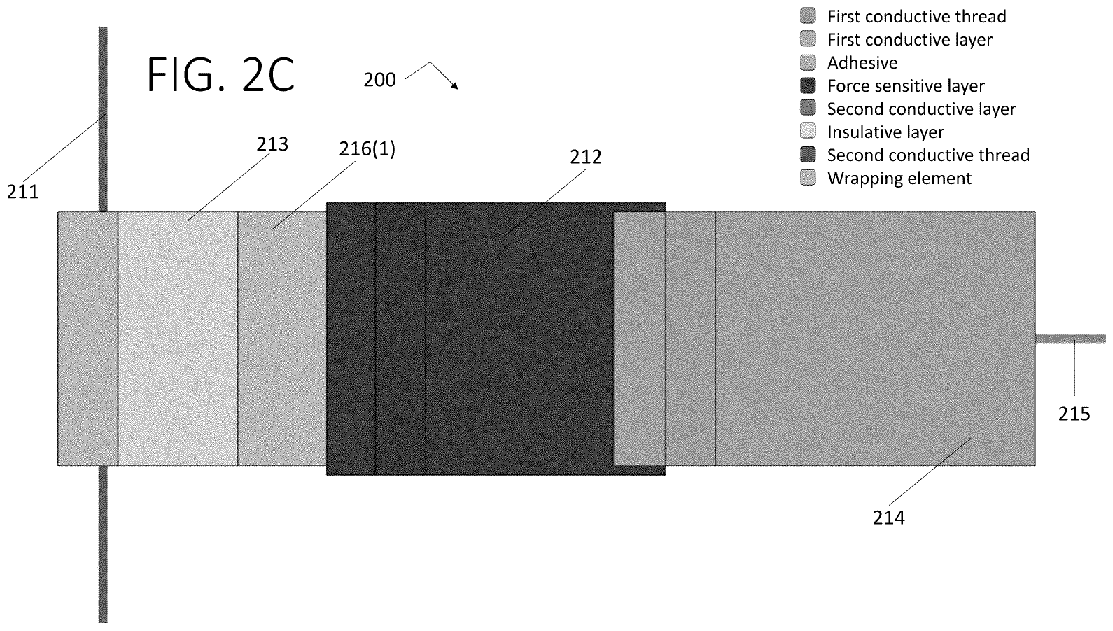

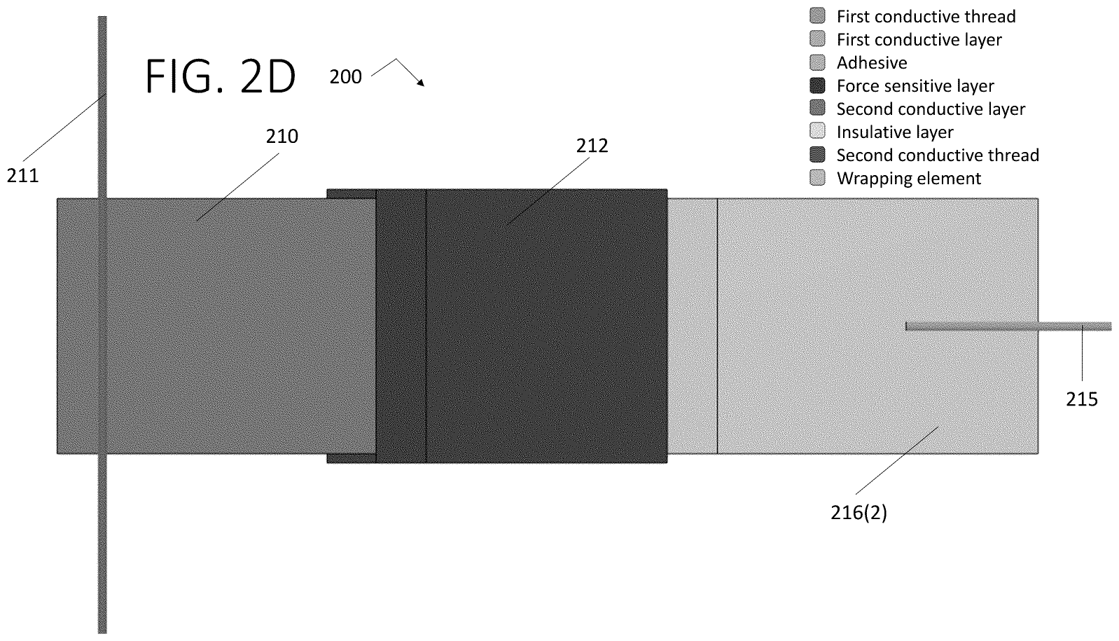

In FIG. 1A, force sensor 100 further includes a fourth layer 113 is adhered to the first layer 210 as provided in FIG. 1A and FIG. 2A. In some embodiments the fourth layer 113 is electrically insulative and the inner most layer. In other such embodiment additional protective layer is adhered to the force sensor. In some embodiments, the fourth layer 113 is omitted.

In some embodiments, the second layer 112 is a force-sensitive layer, e.g., a piezoresistive material, that exhibits force-dependent variable electrical resistance. In some embodiments, force-sensitive layer 212 includes a piezoelectric material, a capacitive sensor, strain gauge, and/or an optical sensor. The second 136 end of the first layer 110 is electrically coupled to the first end 136 of the second layer 112 layer. The second 140 end of the second layer 112 is electrically coupled to the first end 142 of the third layer 114. In some embodiments, the second 136 end of the first layer 110 is mechanically coupled to the first end 136 of the second layer 112 layer. In some embodiments, the second 140 end of the second layer 112 is mechanically coupled to the first end 142 of the third layer 114.

FIG. 2A is a side view of a unrolled sensor 200, and FIG. 2B is a corresponding isometric view of the unrolled sensor 200, in accordance with some embodiments. In some embodiments, the layers are adhered to each other with an adhesive 216. FIGS. 2C-2D are corresponding top and bottom views of the unrolled sensor 200, in accordance with some embodiments.

FIGS. 2A-2D have similarities to FIGS. 1A-1D. FIGS. 2A-2D use 2-series numbering whereas FIGS. 1A-1D use 1-series numbering. A component in FIGS. 2A-2D that corresponds to a component in FIGS. 1A-1D uses a similar number except the former uses a 2-series number whereas the latter uses a 1-series number. For example, the unrolled piezoresistive sensor 200 corresponds to the piezoresistive sensor 100 in an unrolled state, piezoresistive layer 212 corresponds to piezoresistive layer 112, conductive layers 210 and 214 correspond to conductive layers 110 and 114, or the like.

Force sensors for use in virtual reality (VR) systems are an integral part of haptic feedback systems, where the latter enhances the immersive experience by providing users with a sense of touch or force feedback. These sensors are designed to detect and measure the forces exerted by the user and translate them into corresponding virtual interactions or sensations within the VR environment. Force sensors for VR involve various technologies and design considerations to accurately capture and interpret user-generated forces.

Design considerations in force sensors for VR involve factors such as sensitivity, linearity, response time, durability, and size. The sensors should be able to detect a wide range of forces with high accuracy and precision to provide realistic feedback. Additionally, they should be integrated seamlessly into the VR controller or haptic device to ensure user comfort and usability.

Piezoresisitve sensors are widely used in VR applications for capturing and measuring forces. Piezoresisitve sensors utilize materials that exhibit the piezoresisitve effect, where the resistance of a material changes in response to applied mechanical stress. Piezoresisitve materials are chosen based on their sensitivity, stability, and compatibility with the sensor's form factor.

Piezoresisitve sensors for VR typically include a piezoresisitve material, electrodes, and supporting structures. The piezoresisitve material is often shaped as a thin disk or plate to maximize its sensitivity to forces in different directions. The electrodes are applied to the faces of the piezoresisitve material to provide electrical connections for capturing the generated charge. The supporting structures ensure proper mechanical stability and protect the piezoresisitve material.

Changes in the resistance of a piezoresisitve sensor are typically small. To utilize such changes in resistance effectively, signal-conditioning circuitry is employed. In some embodiments, signal-conditioning circuitry includes amplifiers, filters, and analog-to-digital converters (ADCs) correspondingly to amplify, filter, and convert the analog signal into a digital form suitable for processing and integration within the VR system.

In some embodiments, piezoresisitve sensors in VR controllers or haptic devices measure the forces applied by the user's hand or fingers during interactions with virtual objects. By capturing these forces, the VR system can provide corresponding haptic feedback, simulating the sensation of touching or manipulating objects within the virtual environment. The force signals from the piezoresisitve sensors can be used to generate vibrations, resistive forces, or tactile cues, enhancing the sense of immersion and realism.

In some embodiments, piezoresisitve sensors are utilized for gesture recognition in VR applications. By monitoring the forces and pressures exerted by the user's fingers or hand, the sensors detect specific gestures or hand postures. This facilitates intuitive and natural interaction of the user with the virtual environment, facilitating the user's control or manipulation of virtual objects or performance of virtual actions corresponding to hand movements.

In some embodiments, piezoresisitve sensors generate signals which are interpreted as quantitative data representing measurements of forces exerted by users in VR scenarios. This data can be used for research, training, or analysis purposes. For example, in virtual training simulations, the sensors can capture and measure the forces applied during specific tasks, helping in performance evaluation and skill development.

In some embodiments, piezoresisitve sensors are incorporated into input devices and interfaces complementary to the various electronic functions and systems other than VR systems, e.g., textile electronics, other electronics, or the like.

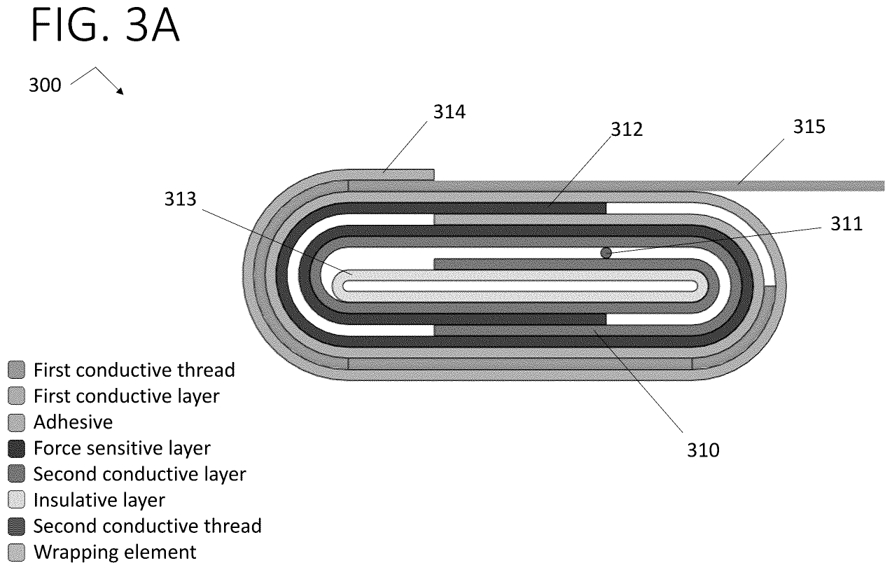

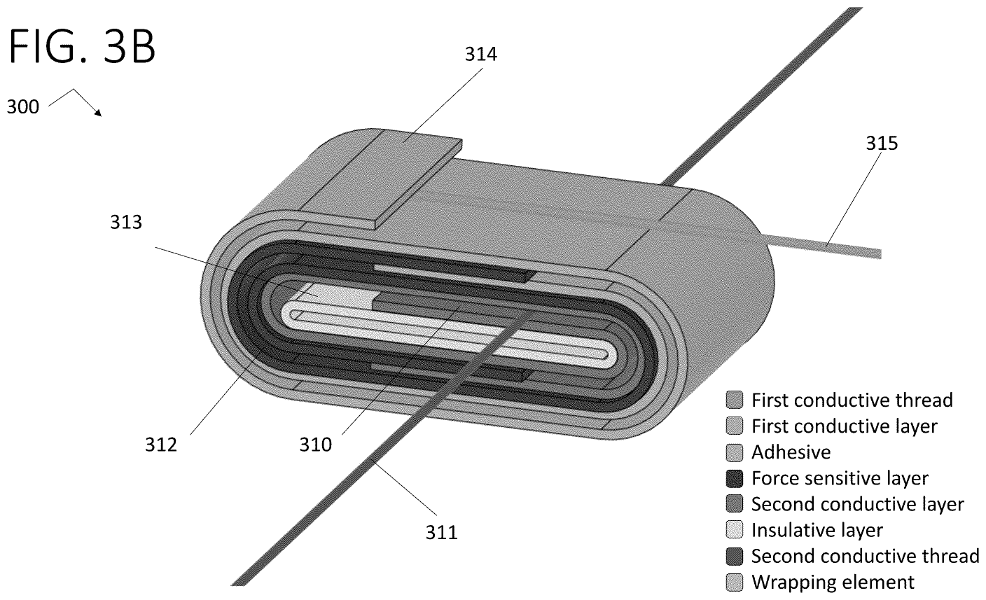

In some embodiments, the force sensor is configured as a flattened spirally-wrapped layer whorl, e.g., FIG. 3A, FIG. 3B and FIG. 5B, where a flattened state is complementary to the various electronic functions.

FIG. 3A-3B are corresponding side and isometric views of a flattened sensor 300 in accordance with some embodiments.

FIGS. 3A-3B have similarities to FIGS. 1A-1D. FIGS. 3A-3B use 3-series numbering whereas FIGS. 1A-1D use 1-series numbering. A component in FIGS. 3A-3B that corresponds to a component in FIGS. 1A-1D uses a similar number except the former uses a 3-series number whereas the latter uses a 1-series number. For example, the unrolled sensor 200 corresponds to the sensor 100 in an unrolled state.

In FIGS. 3A-3B, the force sensor 300 includes electrically conductive layers 314 and 310, a force sensitive layer 312, a common ground 311, and a signal line 315. Compared to, e.g., the force sensor 200 of FIGS. 2A-2D, the force sensor 300 of FIGS. 3A-3B has been flattened resulting in a low profile that facilitates, e.g., incorporation into textile electronics, VR input devices, or the like. In some embodiments, the shape of the force sensor 300 is described as an oval. In some embodiments, the shape of the force sensor 300 is described as a round-cornered rectangle. Suitable signal-conditioning circuitry (not shown) uses the force sensor 300 to generate a signal based on the change in resistance of the electrically conductive layer when force is applied to it, and suitable processing circuitry (not shown) detects changes in the resistance of such a signal.

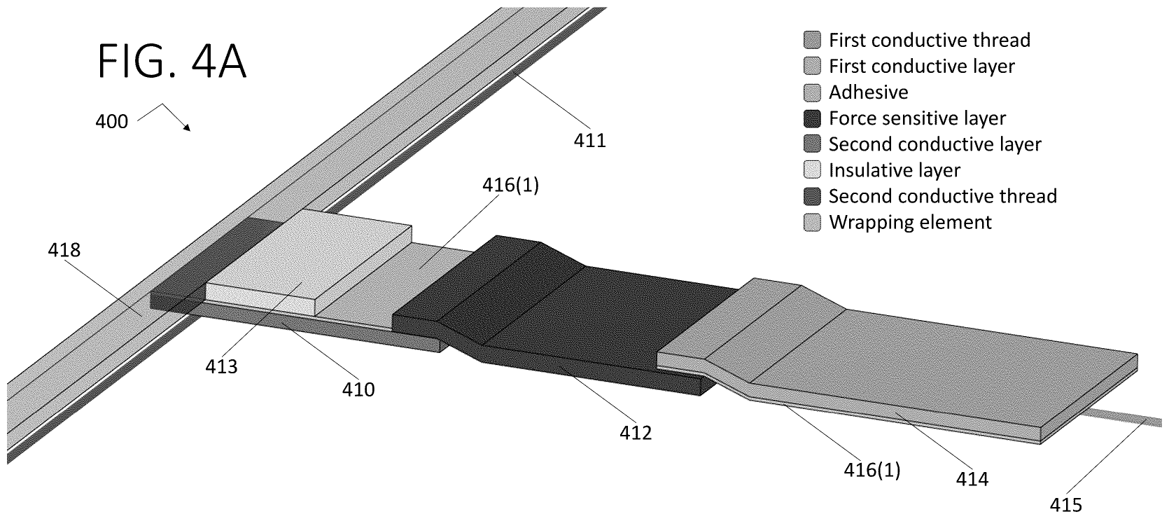

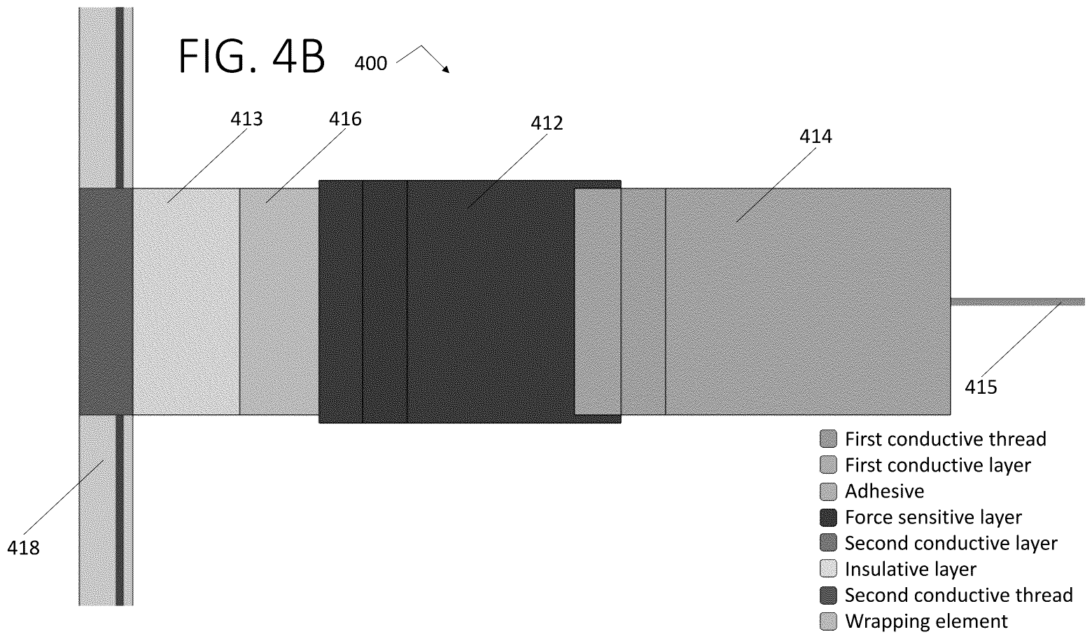

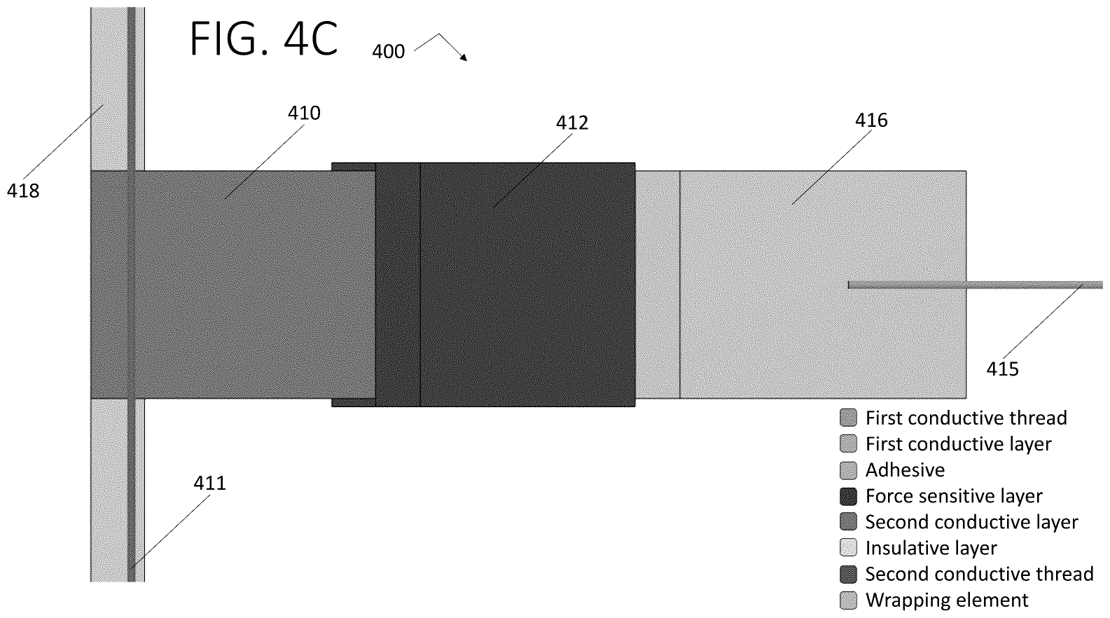

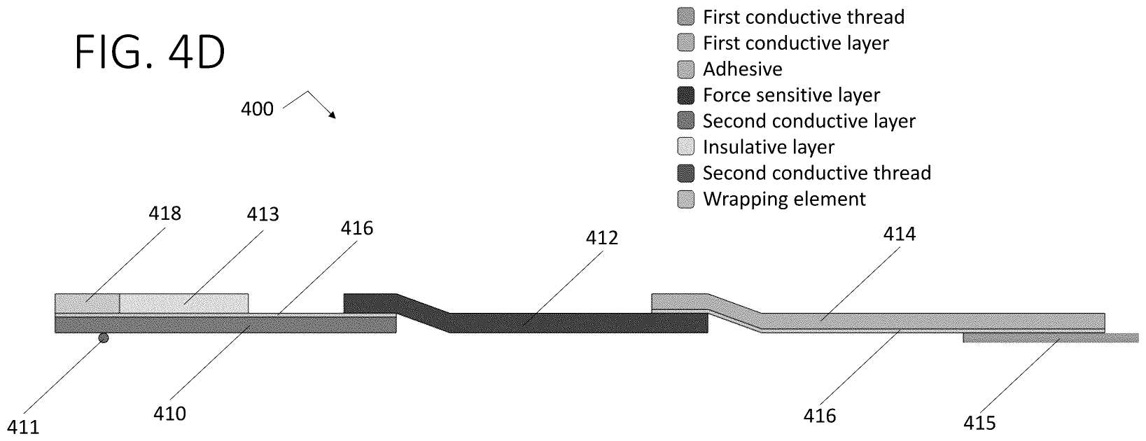

FIGS. 4A-4D are corresponding isometric, top, bottom and side views of an unrolled sensor with a wrapping-element in accordance with some embodiments.

FIG. 5A is an isometric view of a sensor 500A with a wrapping-element in accordance with some embodiments.

FIG. 5B is an isometric view of a flattened sensor 500B with a wrapping-element in accordance with some embodiments.

FIGS. 4A-4D have similarities to FIGS. 2A-2D. FIGS. 4A-4D use 4-series numbering whereas FIGS. 2A-2D use 2-series numbering. A component in FIGS. 4A-4D that corresponds to a component in FIGS. 2A-2D uses a similar number except the former uses a 4-series number whereas the latter uses a 2-series number. For example, the unrolled sensor 400 corresponds to the unrolled sensor 400. FIG. 5A has similarities to FIGS. 1A-1D. FIG. 5A uses 5-series numbering whereas FIGS. 1A-1D use 1-series numbering. A component in FIG. 5A that corresponds to a component in FIGS. 1A-1D uses a similar number except the former uses a 5-series number whereas the latter uses a 1-series number. For example, the sensor 500A corresponds to the sensor 100. FIG. 5B has similarities to FIGS. 3A-3B. FIG. 5B uses 5-series numbering whereas FIGS. 3A-3B use 3-series numbering. A component in FIG. 5B that corresponds to a component in FIGS. 3A-3B uses a similar number except the former uses a 5-series number whereas the latter uses a 3-series number. For example, the sensor 500B corresponds to the sensor 300.

In FIGS. 4A-4D, the coupled layers are shown in an unrolled state, i.e., a state prior to spirally wrapping the same around a wrapping-element 418. From the unrolled state of FIGS. 4A-4D, the coupled layers are wrapped spirally around the wrapping-element 418, where wrapping-element 418 has been wrapped around a mandrel 530 (shown in phantom (dashed) lines in FIG. 5A) resulting the spirally-wrapped layer whorl 500A of FIG. 5A which is disposed around wrapping-element 518. The wrapping-element 418 facilitates temporary attachment to the mandrel 500. From FIG. 5A, the mandrel 530 has been removed and the spirally-wrapped layer whorl 500A has been compressed resulting in the flattened spirally-wrapped layer whorl 500B. In some embodiments, the wrapping-element 518 is retained as a part of the force sensor. In some embodiments, the wrapping-element 518 is removed from the force sensor. In some embodiments, mandrel 518 is removed from the force sensor. In some embodiments, the mandrel 518 is retained as a part of the force sensor.

In some embodiments, in terms of deformability, the wrapping-element 418 is complementary to various functions. In some embodiments, the wrapping-element 418 is pliable. In other such embodiments, the wrapping-element is resilient as provided, e.g., as in FIG. 5A where the wrapping-element 518 conforms to mandrel 530. In some embodiments, mandrel 530 is referred to as die-forming tool.

In some embodiments, the force sensor is incorporated into an array of sensors (not shown), with each force sensor incorporating a force-resistive electrically conductive sensing layer 312 and conductive elements 314 and 310 affixed to the sensing layer 312, the elements being spaced apart such that a change in resistance of the sensing layer 312 upon application of force thereto is detectable. In some of such embodiments, the sensor array shares a common conductive thread 311.

In some embodiments where the force sensor is integrated into a wearable device for measuring force inputs of a user, the wearable device includes a textile glove, a wrist strap coupled to the textile glove, a processor coupled to a memory, at least one sensor array including at least one of the force sensors coupled to a sensor circuit, the wearable device being operative to acquire a force signal.

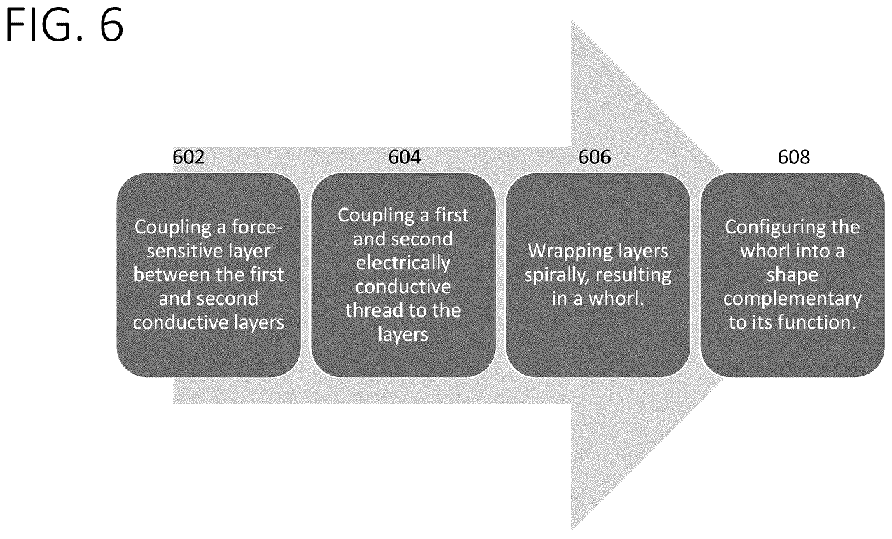

FIG. 6 is a flowchart of a method of manufacturing a force sensor in accordance with some embodiments. Examples the force sensor manufactured according to the flowchart of FIG. 6 include the force sensors disclosed herein, or the like.

The flowchart of FIG. 6 includes blocks 602-608. At block 602, a force-sensitive layer is electrically coupled between a first and second conductive layers. In some embodiments, the force-sensitive layer is also mechanically coupled between the first and second conductive layers. An example of the force-sensitive layer is force-sensitive layer 112, or the like. Examples of the first and second conductive layers include the first conductive layer 210 and the second conductive layer 214, or the like. An example of the force-sensitive layer is a piezoresistive layer, e.g. piezoresistive layer 212, or the like. In some embodiments, an insulative inner (e.g., 213) and/or protective layers are adhered. In some embodiments, the layers are mechanically coupled using, e.g., an adhesive 216. From block 602, flow proceeds to block 604.

At block 604, first and second conductive threads are coupled correspondingly to the first and second conductive layers. Examples of the first and second conductive threads include the first conductive thread 215 and the second conductive thread 211, or the like. In some embodiments, the second conductive thread 211 is a common ground from multiple sensors. From block 604, flow proceeds to block 606.

At block 606, the layers are wrapped spirally, resulting in a spirally-wrapped layer whorl. An example of the spirally-wrapped whorl includes spirally-wrapped whorl 100, or the like. In some embodiments, the coupled layers are wrapped around a wrapping-element, e.g., wrapping-elements 218, 418, or the like. In some embodiments, the coupled layers and the wrapping-element are wrapped around a mandrel, e.g. mandrel 530, or the like. From block 606, flow proceeds to block 608.

At block 608, the layers are configured into a shape complementary to their function. In some embodiments, the spirally-wrapped whorl is compressed into a flattened spirally-wrapped whorl. An example of the flattened spirally-wrapped whorl is the flattened spirally-wrapped whorl 300, or the like.

In some embodiments, the wrapping-element (e.g., 218) is removed. In other such embodiments, the wrapping-element (e.g., 218) is retained as part of the sensor for structure. In some embodiments, the mandrel (e.g., 518) is removed from the force sensor. In some embodiments, the mandrel (e.g., 518) is retained as a part of the force sensor.

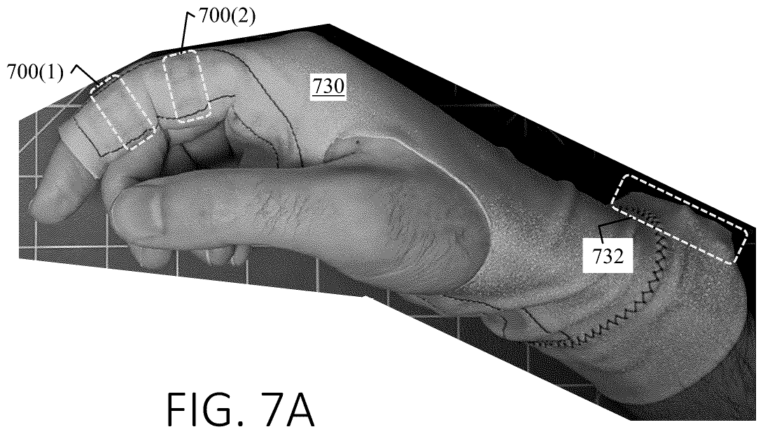

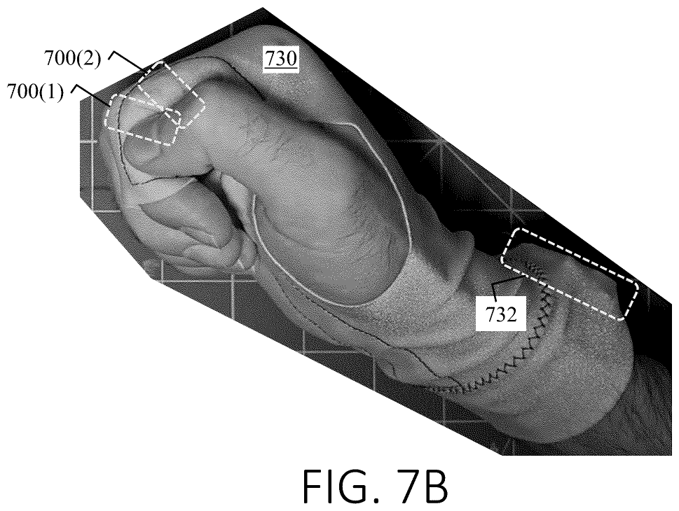

FIGS. 7A-7B are corresponding top views of a glove 730 that incorporates piezoresistive sensors, in accordance with some embodiments.

In FIG. 7A, glove 730 includes piezoresistive sensors 700(1) and 700(2) and signal-conditioning circuitry 732, each of which is, e.g., sewn into glove 730. Piezoresistive sensors 700(1) and 700(2) are coupled to signal-conditioning circuitry 732.

When glove 730 is worn on a user's hand: piezoresistive 700(1) is proximal to the radial side of the middle phalanx of the index finger (D2 finger); and piezoresistive 700(2) is proximal to the radial side of the proximal phalanx of the index finger (D2 finger). In glove 730, each of piezoresistive sensors 700(1) and 700(2) functions as a corresponding button-actuator.

In FIG. 7B, the pad of user's thumb is applying pressure to piezoresistive 700(1). That is, the user's thumb is actuating the button-actuator represented by piezoresistive 700(1).

In some embodiments, multiple instances of the force sensor are integrated into an array and coupled correspondingly to signal-conditioning circuits, the latter being coupled with a user interface. In some embodiments, an array as such is realized as a wearable device having flexible properties, i.e., as an instance of textile electronics. This solution is cheaper, more flexible, and has a comfortable interface to the skin compared to alternatives. Additionally, the cost-effectiveness of textile electronics as such facilitates including a relatively greater number of such force sensors as compared to alternative force sensors.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A force sensor arrangement comprising:
first, second, and third layers stacked and wrapped in a spiraled arrangement relative to a cylindrical coordinate system (CCS) having a cylindrical axis extending in a first direction,
the first, second and third layers being stacked relative to a radial axis of the CCS;
the first, second and third layers correspondingly having:
length axes extending in a second direction and perpendicular to each of the cylindrical axis and the radial axis of the CCS and width axes extending parallel the cylindrical axis and perpendicular to the radial axis;
relative to the radial axis:
first and second ends of the first, second, and third layers correspondingly being proximal and distal to the cylindrical axis;
the first end of the second layer being between the first and second ends of the first layer;
the first end of the third layer being between the first and second ends of the second layer;
the first and third layers being electrical conductors; and
the second layer exhibiting a force-dependent variable electrical resistance;
the second end of the first layer being coupled to the first end of the second layer; and
the second end of the second layer being coupled to the first end of the third layer.

2. The force sensor arrangement of claim 1, wherein:
the force sensor is configured in an oval shape.

3. The force sensor arrangement of claim 1, wherein:
the force sensor arrangement is integrated into glove.

4. The force sensor arrangement of claim 3, wherein:
the force sensor arrangement is integrated into a finger of the glove.

5. A force sensor comprising:
first, second, and third layers correspondingly having first and second ends and first and second sides;
first and second conductive threads correspondingly having first and second ends;
the first and third layers including an electrically conductive material;
the second layer including a force sensitive material;
the second end of the second side of the first layer being coupled to the first end of the first side of the second layer;
the second end of the second side of the second layer being coupled to the first end of the first side of the third layer;
the first end or an area proximal thereto of the first thread being coupled to the first layer;
the first end or an area proximal thereto of the second thread being coupled to the third layer;
a first portion of the first layer being wrapped spirally upon itself;
the first side of the first layer being coupled to the second side of the first layer;
the second layer being wrapped spirally upon the first layer;
the first side of the second layer being coupled to the second side of the first layer and the second side of the second layer;
the third layer being wrapped spirally upon the second layer; and
the first side of the third layer coupling to the second side of the second layer and the second side of the third layer;

6. The force sensor of claim 5, wherein:
the electrically conductive material is copper or a copper-based alloy.

7. The force sensor of claim 5, wherein:
the force-sensitive material is a piezoresistive material layer. 8 The force sensor of claim 5, wherein:
the force-sensitive material is a piezoelectric material layer.

9. The force sensor of claim 5, wherein:
the first and second conductive threads correspondingly carry a signal and a reference voltage.

10. The force sensor of claim 9, wherein:
the ground thread is common to a plurality of sensors.

11. The force sensor of claim 9, wherein:
a portion of at least one of the conductive threads is aligned substantially parallel to the cylindrical axis.

12. The force sensor of claim 5, further comprising:
a fourth layer that includes an electrically insulative material; and
wherein:
the fourth layer is adhered to the first side of the first layer; and
amongst the first to fourth layers, the fourth layer is most radially inward relative to the cylindrical axis.

13. The force sensor of claim 5, wherein:
a width of the second layer larger than the widths of the first to third layers.

14. The force sensor of claim 5, further comprising:
at least one protective layer wherein the first, second and third layers are disposed between the protective layers.

15. A method of manufacturing a force sensor, the method comprising:
electrically coupling a force-sensitive layer between first and second conductive layers;
electrically coupling first and second conductive lines correspondingly to the first and second conductive layers; and
wrapping the first and second conductive layers and force-sensitive material layers spirally, resulting in a spirally-wrapped layer whorl.

16. The method of claim 15, further comprising:
flattening the spirally-wrapped layer whorl into an oval shape.

17. The method of claim 15, wherein the wrapping includes:
wrapping the coupled layers wrapped around at least one wrapping-element.

18. The method of claim 17, wherein the wrapping includes:
wrapping the first and second conductive layers, the force-sensitive material layer and the wrapping-element spirally around a mandrel.

19. The method of claim 15, further comprising:
mechanically coupling the force-sensitive layer to the first conductive layer; and
mechanically coupling the second conductive layer to the force-sensitive layer.

20. The force sensor of claim 19, wherein:
the mechanically coupling the force-sensitive layer to the first conductive layer includes:
adhering the force-sensitive layer to the first conductive layer; and
the mechanically coupling the second conductive layer to the force-sensitive layer includes:
adhering the second conductive layer to the force-sensitive layer.
